(19) United States
(12) Patent Application Publication
(10) Pub. No.: US 2024/0373443 A1
(43) Pub. Date: Nov. 7, 2024

(54) PARAMETER-LEVEL COORDINATION FOR SIDELINK COMMUNICATION IN A DISTRIBUTED SCHEDULING MODE

(71) Applicant: QUALCOMM Incorporated, San Diego, CA (US)

(72) Inventors: Stelios STEFANATOS, San Diego, CA (US); Arthur GUBESKYS, San Diego, CA (US); Libin LIU, Monterey Park, CA (US); Tien Viet NGUYEN, Bridgewater, NJ (US); Gabi SARKIS, San Diego, CA (US); Guangyi LIU, Shanghai (CN)

(21) Appl. No.: 18/683,722

(22) PCT Filed: Sep. 14, 2022
(86) PCT No.: PCT/US2022/076396

§ 371 Date: Feb. 14, 2024

(30) Foreign Application Priority Data
Oct. 29, 2021 (GR) 20210100747

(51) Int. Cl. H04W 72/25; H04W 4/02; H04W 72/12

(52) U.S. Cl. CPC H04W 72/25; H04W 4/02; H04W 72/12

(57) ABSTRACT

Various aspects of the present disclosure generally relate to wireless communication. In some aspects, a user equipment (UE) may receive coordination information for sidelink communication in a distributed scheduling mode. The UE may select, in the distributed scheduling mode, a value for a sidelink communication parameter based at least in part on the coordination information. The UE may transmit a sidelink communication using the value of the sidelink communication parameter that is selected based at least in part on the coordination information. Numerous other aspects are described.

### CROSS-REFERENCE TO RELATED APPLICATION

This Patent Application claims priority to Greek patent application Ser. No. 20210100747, filed on Oct. 29, 2021, entitled “PARAMETER-LEVEL COORDINATION FOR SIDELINK COMMUNICATION IN A DISTRIBUTED SCHEDULING MODE,” which is hereby expressly incorporated by reference herein.

### FIELD OF THE DISCLOSURE

Aspects of the present disclosure generally relate to wireless communication and to techniques and apparatuses for parameter-level coordination for sidelink communication in a distributed scheduling mode.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive coordination information for sidelink communication in a distributed scheduling mode. The one or more processors may be configured to select, in the distributed scheduling mode, a value for a sidelink communication parameter based at least in part on the coordination information. The one or more processors may be configured to transmit a sidelink communication using the value of the sidelink communication parameter that is selected based at least in part on the coordination information.

Some aspects described herein relate to a coordination node for wireless

communication. The coordination node may include a memory and one or more processors coupled to the memory. The one or more processors may be configured to generate coordination information for sidelink communication in a distributed scheduling mode. The one or more processors may be configured to transmit the coordination information to one or more UEs, wherein the coordination information indicates a value that the one or more UEs are to use for a sidelink communication parameter or indicates whether one or more sidelink features or procedures are enabled or disabled.

Some aspects described herein relate to a method of wireless communication performed by a UE. The method may include receiving coordination information for sidelink communication in a distributed scheduling mode. The method may include selecting, in the distributed scheduling mode, a value for a sidelink communication parameter based at least in part on the coordination information. The method may include transmitting a sidelink communication using the value of the sidelink communication parameter that is selected based at least in part on the coordination information.

Some aspects described herein relate to a method of wireless communication performed by a coordination node. The method may include generating coordination information for sidelink communication in a distributed scheduling mode. The method may include transmitting the coordination information to one or more UEs, wherein the coordination information indicates a value that the one or more UEs are to use for a sidelink communication parameter or indicates whether one or more sidelink features or procedures are enabled or disabled.

Some aspects described herein relate to a non-transitory computer-readable medium that stores a set of instructions for wireless communication by a UE. The set of instructions, when executed by one or more processors of the UE, may cause the UE to receive coordination information for sidelink communication in a distributed scheduling mode. The set of instructions, when executed by one or more processors of the UE, may cause the UE to select, in the distributed scheduling mode, a value for a sidelink communication parameter based at least in part on the coordination information. The set of instructions, when executed by one or more processors of the UE, may cause the UE to transmit a sidelink communication using the value of the sidelink communication parameter that is selected based at least in part on the coordination information.

Some aspects described herein relate to a non-transitory computer-readable medium that stores a set of instructions for wireless communication by a coordination node. The set of instructions, when executed by one or more processors of the coordination node, may cause the coordination node to generate coordination information for sidelink communication in a distributed scheduling mode. The set of instructions, when executed by one or more processors of the coordination node, may cause the coordination node to transmit the coordination information to one or more UEs, wherein the coordination information indicates a value that the one or more UEs are to use for a sidelink communication parameter or indicates whether one or more sidelink features or procedures are enabled or disabled.

Some aspects described herein relate to an apparatus for wireless communication. The apparatus may include means for receiving coordination information for sidelink communication in a distributed scheduling mode. The apparatus may include means for selecting, in the distributed scheduling mode, a value for a sidelink communication parameter based at least in part on the coordination information. The apparatus may include means for transmitting a sidelink communication using the value of the sidelink communication parameter that is selected based at least in part on the coordination information.

Some aspects described herein relate to an apparatus for wireless communication. The apparatus may include means for generating coordination information for sidelink communication in a distributed scheduling mode. The apparatus may include means for transmitting the coordination information to one or more UEs, wherein the coordination information indicates a value that the one or more UEs are to use for a sidelink communication parameter or indicates whether one or more sidelink features or procedures are enabled or disabled.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating examples of sidelink communications in different coverage scenarios, in accordance with the present disclosure.

FIG. 5 is a diagram illustrating an example associated with parameter-level coordination for sidelink communication in a distributed scheduling mode, in accordance with the present disclosure.

FIGS. 6-7 are diagrams illustrating example processes associated with parameter-level coordination for sidelink communication in a distributed scheduling mode, in accordance with the present disclosure.

FIGS. 8-9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

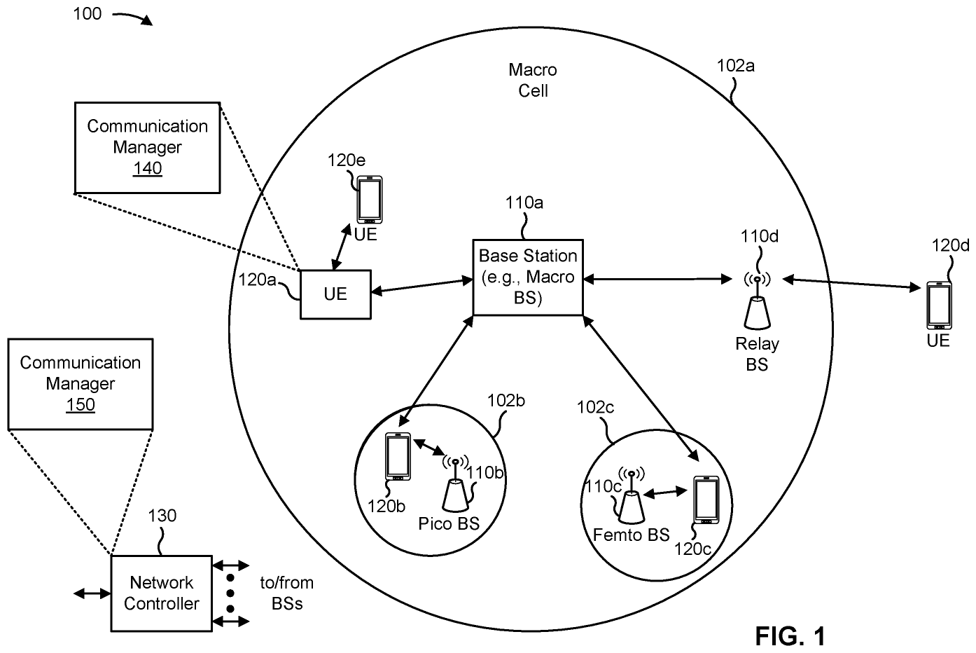

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell. a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition. higher frequency bands are currently being explored to extend 5G NR operation beyond 52.6 GHz. For example. three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz. may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive coordination information for sidelink communication in a distributed scheduling mode; select, in the distributed scheduling mode, a value for a sidelink communication parameter based at least in part on the coordination information; and transmit a sidelink communication using the value of the sidelink communication parameter that is selected based at least in part on the coordination information. Additionally, or alternatively, the communication manager 140 may perform one or more other operations described herein.

In some aspects, the network controller 130 may include a communication manager 150. As described in more detail elsewhere herein, the communication manager 150 may generate coordination information for sidelink communication in a distributed scheduling mode; and transmit the coordination information to one or more UEs 120, wherein the coordination information indicates a value that the one or more UEs 120 are to use for a sidelink communication parameter or indicates whether one or more sidelink features or procedures are enabled or disabled. Additionally, or alternatively, the communication manager 150 may perform one or more other operations described herein.

As indicated above, FIG. 1 is provided as an example. Other examples may differ from what is described with regard to FIG. 1.

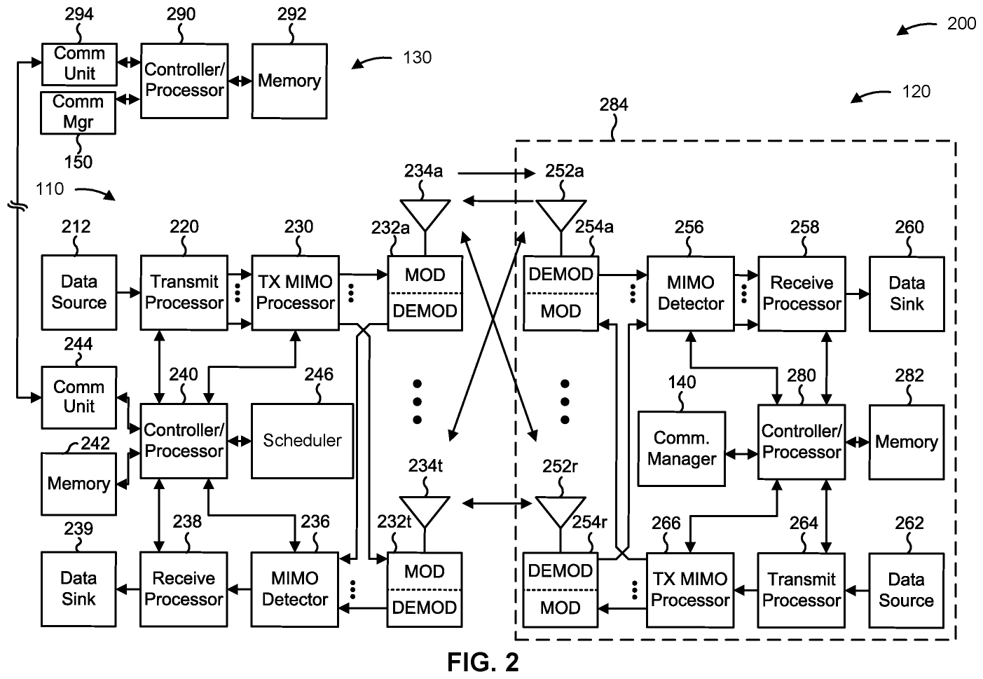

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

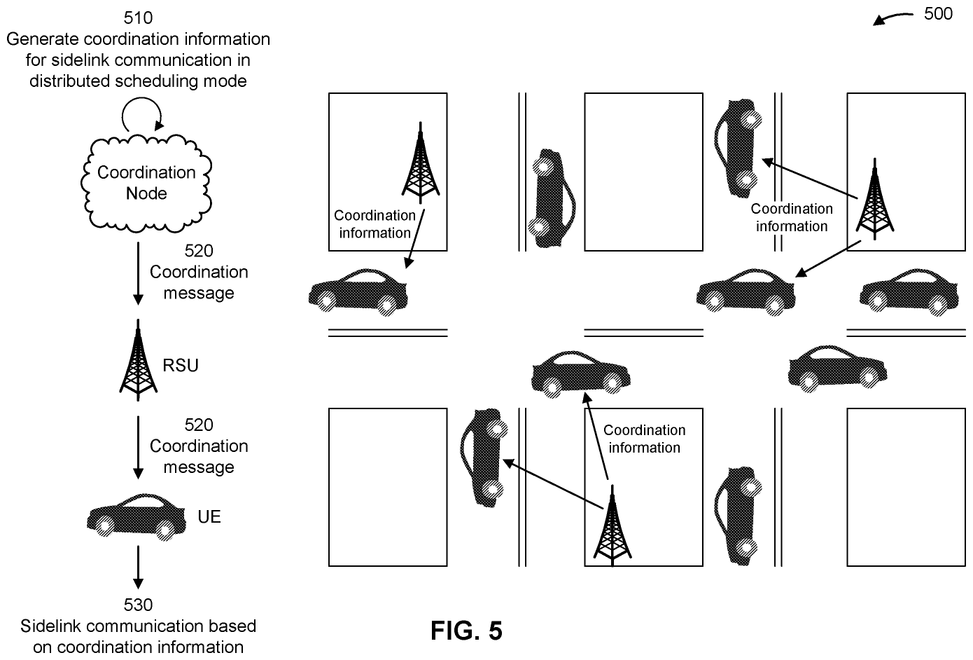

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

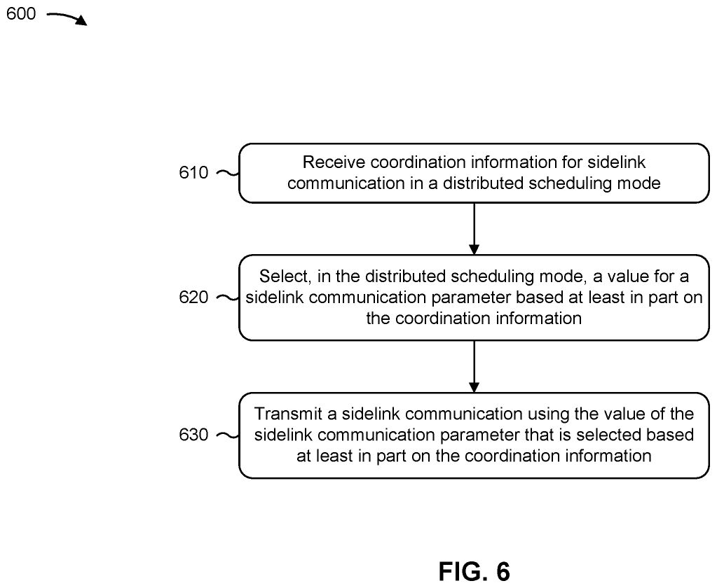

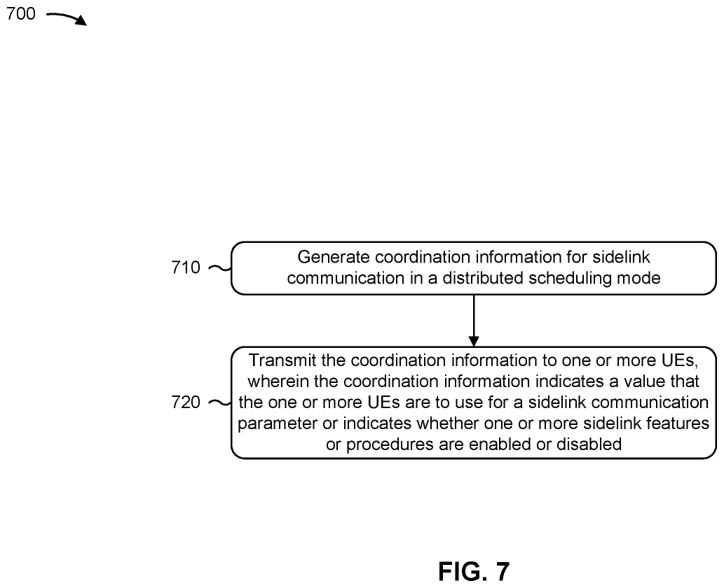

The controller/processor 240 of the base station 110, the controller/processor 280 of the UE 120, and/or any other component(s) of FIG. 2 may perform one or more techniques associated with parameter-level coordination for sidelink communication in a distributed scheduling mode, as described in more detail elsewhere herein. In some aspects, the coordination node described herein is the network controller 130, is included in the network controller 130, or includes one or more components of the network controller 130 shown in FIG. 2. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242, the memory 282, and the memory 292 may store data and program codes for the base station 110, the UE 120, and the network controller 130, respectively. In some examples, the memory 242, the memory 282, and/or the memory 292 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110, the UE 120, and/or the network controller 130, may cause the one or more processors, the base station 110, the UE 120, and/or the network controller 130 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving coordination information for sidelink communication in a distributed scheduling mode; means for selecting, in the distributed scheduling mode, a value for a sidelink communication parameter based at least in part on the coordination information; and/or means for transmitting a sidelink communication using the value of the sidelink communication parameter that is selected based at least in part on the coordination information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the coordination node includes means for generating coordination information for sidelink communication in a distributed scheduling mode; and/or means for transmitting the coordination information to one or more UEs 120, wherein the coordination information indicates a value that the one or more UEs 120 are to use for a sidelink communication parameter or indicates whether one or more sidelink features or procedures are enabled or disabled. In some aspects, the means for the coordination node to perform operations described herein may include, for example, one or more of communication manager 150, communication unit 294, controller/processor 290, or memory 292.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

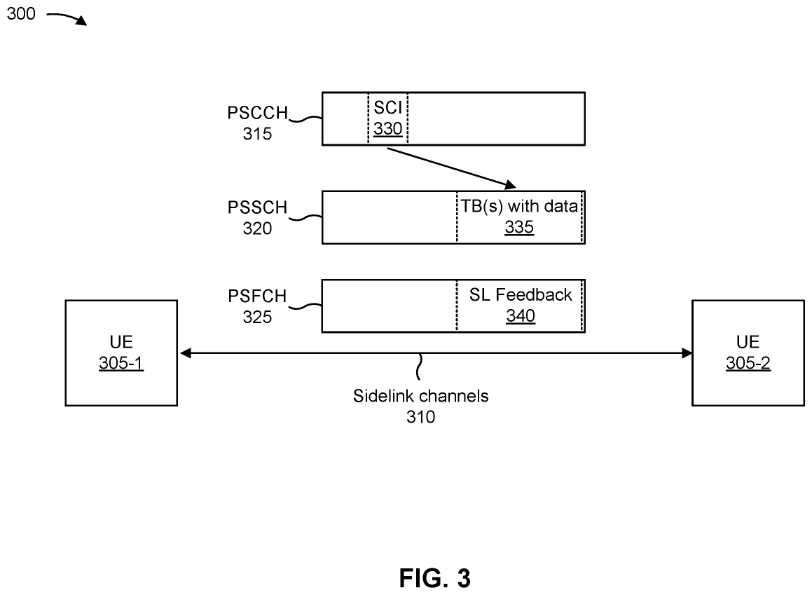

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a first sidelink transmission mode (e.g., Mode 1, which may be referred to herein as a centralized scheduling mode or a network-controlled scheduling mode) in which resource selection and/or scheduling is performed by a base station 110. For example, in the centralized or network-controlled scheduling mode, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a second sidelink transmission mode (e.g., Mode 2, which may be referred to herein as a distributed scheduling mode or an autonomous scheduling mode) in which resource selection and/or scheduling is performed by the UE 305 (e.g., rather than a base station 110). In some aspects, the UE 305 may perform resource selection and/or scheduling in the distributed or autonomous scheduling mode by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling in the distributed or autonomous scheduling mode using SCI 330 received in the PSCCH 315, which may indicate occupied resources and/or channel parameters. Additionally. or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the distributed or autonomous scheduling mode, where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with regard to FIG. 3.

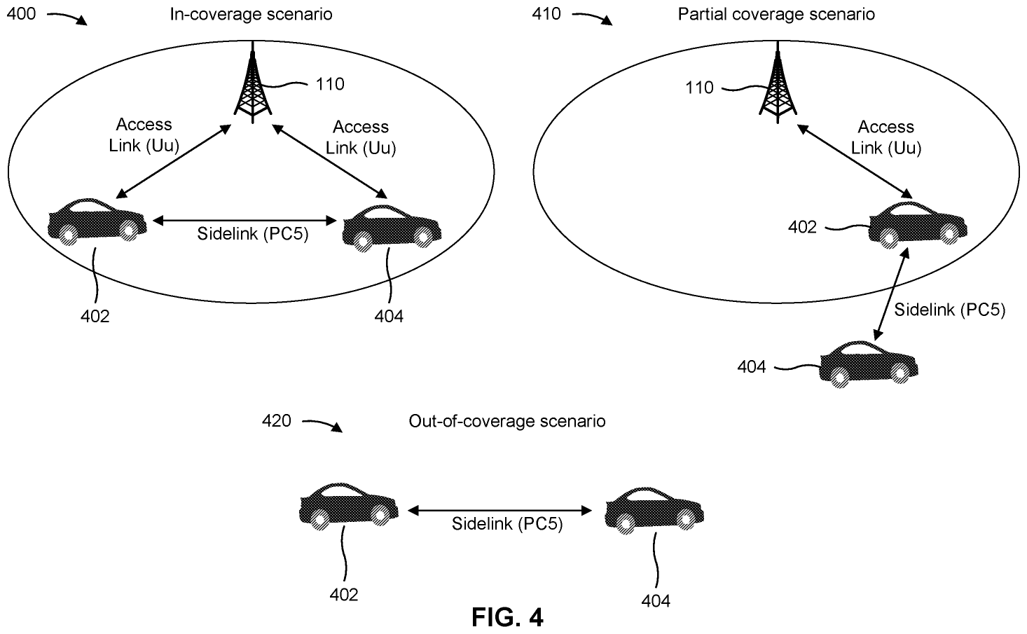

FIG. 4 is a diagram illustrating examples of sidelink communications in different coverage scenarios 400, 410, 420, in accordance with the present disclosure. For example, FIG. 4 illustrates an example of sidelink communications in an in-coverage scenario 400, an example of sidelink communications in a partial coverage scenario 410, and an example of sidelink communications in an out-of-coverage scenario 420.

As shown in FIG. 4, in the in-coverage scenario 400, a transmitter (Tx)/receiver (Rx) UE 402 and an Rx/Tx UE 404 may communicate with one another via a sidelink (e.g., a PC5 interface), as described above in connection with FIG. 3, and a base station 110 may communicate with the Tx/Rx UE 402 via a first access link and with the Rx/Tx UE 404 via a second access link (e.g., respective Uu interfaces). As shown, in the in-coverage scenario 400, the Tx/Rx UE 402 and the Rx/Tx UE 404 are both within the coverage of the base station 110, whereby sidelink communication between the Tx/Rx UE 402 and the Rx/Tx UE 404 may be performed in a centralized or network-controlled scheduling mode (e.g., Mode 1) where sidelink resources are scheduled by the base station 110, or in a distributed or autonomous scheduling mode (e.g., Mode 2) where the UEs 402/404 autonomously select sidelink resources from a configured sidelink resource pool based on a channel sensing mechanism.

As further shown in FIG. 4, in the in-coverage scenario 410, a Tx/Rx UE 402 is within the coverage area of a base station 110, and an Rx/Tx UE 404 is outside the coverage area of the base station. In the in-coverage scenario 410, the Tx/Rx UE 402 and the Rx/Tx UE 404 may communicate with one another via a sidelink (e.g., a PC5 interface), and the base station 110 may communicate with the Tx/Rx UE 402 via an access link (e.g., a Uu interface). Accordingly, in the in-coverage scenario 410, the base station 110 may enable either the centralized scheduling mode or the distributed scheduling mode for the Tx/Rx UE 402 within the coverage area of the base station 110, and the Rx/Tx UE 404 that is out-of-coverage may use only the distributed scheduling mode. Furthermore, in the out-of-coverage scenario 420, the Tx/Rx UE 402 and the Rx/Tx UE 404 are outside the coverage area of any base station. Accordingly, in the out-of-coverage scenario 420, only the distributed scheduling mode can be used to enable sidelink communication between the Tx/Rx UE 402 and the Rx/Tx UE 404.

As described herein, when a UE is to perform a sidelink transmission, the sidelink transmission may be performed according to one or more sidelink procedures and/or using one or more transmission parameters that are configured to streamline a channel access scheme that sidelink UEs follow either in the centralized or network-controlled scheduling mode or in the distributed or autonomous scheduling mode. In general, all communication parameters (e.g., transmission parameters such as transmit power and/or DMRS pattern, and procedural parameters indicating whether certain sidelink features and/or procedures are enabled or disabled) are centrally selected or otherwise controlled by the network in the centralized scheduling mode (e.g., Mode 1). For example, in the centralized scheduling mode, a base station is aware of congestion, traffic conditions, interference, load, and/or other factors that may impact performance of the base station and the UEs within the coverage area of the base station, and the base station configures the sidelink communication parameters accordingly to optimize overall sidelink and/or cellular performance and/or per-UE performance.

On the other hand, in the distributed scheduling mode, there are various sidelink communication parameters that are independently or autonomously selected by a transmitting UE. For example, in the distributed scheduling mode, sidelink communication parameters may include globally configured parameters that have fixed values (e.g., a number of subchannels, a bandwidth of the subchannels, and/or a slot duration, among other examples) and locally configured parameters whose selection is left to the transmitting UE. For example. the locally configured parameters may include an MCS, a DMRS pattern, a transmit power, a maximum number of retransmissions for a given TB. a groupcast option 1 NACK distance (e.g., a distance over which a receiving UE can send a NACK for a sidelink transmission), and/or a beta parameter (e.g., related to coding associated with a transmitted waveform), among other examples. In some cases. the transmitting UE may select the locally configured parameters independently, possibly restricted over a set of allowed or permitted values, with the locally configured parameters having values that are selected by the UE in order to optimize performance of the UE with respect to one or more metrics that are typically application-dependent. For example, a transmitting UE may select an MCS and a maximum number of HARQ retransmissions to maximize packet reliability, maximize throughput, and/or minimize latency, among other examples. Furthermore. the transmitting UE may select the locally configured parameters according to a preconfigured scheme (e.g., using a default value that may be application-dependent, such as a default value for a basic safety message (BSM)) and/or using more sophisticated techniques based on on-the-fly (e.g., current or instantaneous) measurements such as a CBR or perceived congestion on a sidelink channel.

As described above, in cases where one or more transmitting UEs independently or autonomously select one or more locally configured sidelink communication parameters in the distributed scheduling mode, the transmitting UEs select the parameter values to optimize local performance with respect to one or more performance metrics. However, independent (selfish) selection of the sidelink communication parameters may result in suboptimal or unstable overall performance (e.g., by various UEs engaged in sidelink communication) and/or suboptimal or unstable per-UE performance. For example. when a sidelink transmission is performed using groupcast option 1, where only receiving UEs that are within a specified distance from the transmitting UE are permitted to send NACK feedback to trigger a retransmission, the sidelink transmission may be associated with a locally configured parameter that defines a NACK distance threshold. For example, the NACK distance threshold is typically associated with application reliability requirements, based on a distance over which a sidelink transmission needs to be reliably received (e.g., if a sidelink transmission needs to be reliably received by all vehicles within X meters from the transmitting UE, the NACK distance threshold may be set to a value equal to or greater than X meters).

At an extreme, when all UEs making an independent and selfish selection, every transmitting UE may select the largest allowable value for the NACK distance threshold in order to cover all possible reliability requirements (e.g., with respect to link distance) without having to perform any adaptation (e.g., to varying reliability requirements that may be required by transmissions corresponding to different applications). In this case, selecting the largest allowable value for the NACK distance threshold may result in many retransmissions being unnecessarily triggered for sidelinks that have little or no interest (e.g., very long distance links that are irrelevant for most applications), which may result in unnecessary congestion degrading overall sidelink performance (e.g., increasing collisions and/or packet losses) for all UEs. In contrast, if the NACK distance threshold were to be coordinated (e.g., different UEs select locally optimal values for the NACK distance threshold), system performance and individual UE performance may improve. For example, in a wireless network where all UEs operate using groupcast option 1 and select the same NACK distance threshold. an average packet reception rate (PRR) may be sensitive to the selected value for the NACK distance threshold. Ideally, overall system performance may be optimized by achieving a certain PRR (e.g., at least 90%) at a maximum possible distance. Accordingly, because overall (average system-wide) PRR performance is sensitive to the NACK distance threshold, an optimal value for the NACK distance threshold that achieves the best overall PRR performance at any given distance may differ from UE-specific reliability requirements. For example, if setting the NACK distance threshold to a value greater than 100 meters would result in a highest PRR at a 50 meter distance, some UEs may experience suboptimal performance if all UEs were to independently select a NACK distance threshold of 50 meters to maximize reliability at 50 meters. In this example, coordinating the NACK distance threshold such that all UEs use a NACK distance of at least 100 meters may improve overall and individual PRR performance. However, current wireless networks and/or wireless communication standards lack any mechanisms that may enable such coordination for sidelink operation performed in the distributed or autonomous scheduling mode (e.g., Mode 2 sidelink operation).

Accordingly, some aspects described herein relate to techniques and apparatuses associated with parameter-level coordination for sidelink communication in a distributed scheduling mode. For example, as described herein, a coordination node (e.g., a cloud entity or another suitable centralized node) may generate coordination information that indicates values and/or selection criteria for one or more locally configured sidelink communication parameters, which may generally include numerical values for one or more sidelink transmission parameters and/or sidelink procedure parameters (e.g., information that indicates whether one or more sidelink features or procedures are enabled or disabled). In some aspects, as described herein, the coordination node may select one or more locally configured sidelink communication parameters to be coordinated in the distributed scheduling mode, and may generate coordination information that indicates the values and/or other selection criteria associated with the coordinated sidelink parameters. For example, in some aspects, the sidelink communication parameters to be coordinated and/or the values or other selection criteria associated with the coordinated parameters may be selected by the coordination node to optimize or improve overall sidelink performance (e.g., to maximize the average or sum performance over the network). Furthermore, as described herein, the parameter-level coordination in the distributed scheduling mode may be simpler to achieve than the full coordination used in the centralized scheduling mode (which may be fundamentally impossible in cases where the distributed scheduling mode is used for out-of-coverage UEs). For example, the parameter-level coordination in the distributed scheduling mode may limit coordination to a curated set of parameters that have a key impact on overall system performance and/or per-UE performance and may be updated at a relatively slow rate.

As indicated above, FIG. 4 is provided as an example. Other examples may differ from what is described with regard to FIG. 4.

FIG. 5 is a diagram illustrating an example 500 associated with parameter-level coordination for sidelink communication in a distributed scheduling mode, in accordance with the present disclosure. As shown in FIG. 5, example 500 includes communication between a coordination node (e.g., a cloud entity), various UEs performing sidelink communication in a distributed scheduling mode, and one or more roadside units (RSUs), terminals, or other suitable hardware entities that may be deployed to assist sidelink communication in an area where sidelink communication is performed in the distributed scheduling mode (e.g., an out-of-coverage area).

For example, as shown in FIG. 5, various UEs may be configured to perform sidelink communications in the distributed scheduling mode in a geographical area that is served or otherwise covered by the coordination node. Accordingly, as shown by reference number 510, the coordination node may generate coordination information associated with one or more sidelink communication parameters that are locally configured or locally selected in the distributed scheduling mode. For example, as described above, the distributed scheduling mode may include various globally configured parameters used by all UEs and various locally configured parameters that UEs are permitted to select independently or autonomously. In some aspects, the coordination node may generate the coordination information for one or more of the locally configured parameters, which may include numerical values for one or more sidelink transmission parameters (e.g., a transmit power and/or a NACK distance threshold for groupcast option 1) and/or information to indicate whether to enable or disable one or more sidelink features or sidelink procedures (e.g., whether to enable or disable retransmissions and/or inter-UE coordination).

In some aspects, as described herein, the coordination node may apply one or more machine learning techniques to determine the one or more sidelink communication parameters to be coordinated and to determine the values of the coordinated sidelink communication parameters. For example, during a training or learning stage, the coordination node may test the system by obtaining one or more observations that relate to performance for different values for one or more sidelink communication parameters and different combinations of values for different sidelink communication parameters with respect to one or more key performance indicators. Accordingly, the coordination node may observe how different parameter values and combinations of parameter values perform with respect to a key performance indicator of interest, and may identify a set of sidelink communication parameters to be coordinated and select values for the coordinated set of sidelink communication parameters using machine learning techniques. For example, the coordination node may apply an action space exploitation and exploration principle associated with a reinforcement learning technique to identify which sidelink communication parameters to coordinate and which values and/or selection criteria to configure for the sidelink communication parameters to coordinate (e.g., by observing performance benefits or rewards that are achieved by coordinating certain parameters and/or parameter values). Furthermore, after the training or learning stage, the coordination node may continue to observe how the selection of the sidelink communication parameters and/or the values or selection criteria impact performance. In this way, the coordination node may continue to apply machine learning techniques (e.g., reinforcement learning) to reselect and/or modify the sidelink communication parameters that are coordinated and/or the values or selection criteria that are used for the coordinated sidelink communication parameters. In this way, the coordination node may, over time, continue to learn and adapt to environment changes that may impact the optimal sidelink communication parameters to coordinate and/or the values to use for the coordinated parameters.

As further shown in FIG. 5, and by reference number 520, the coordination node may communicate the coordination information to one or more UEs such that the UEs receiving the coordination information all use the parameter values indicated in the coordination information. For example, in some aspects, the coordination node may generate a coordination message that carries the coordination information, which the coordination node may transmit or otherwise communicate to the UEs that are served by (e.g., in the geographical area controlled by) the coordination node in a coordination message that is transmitted via the one or more RSUs. Accordingly, as shown by reference number 530, a UE that receives the coordination message may select values for one or more sidelink communication parameters (e.g., a parameter value that relates to a sidelink transmission and/or a parameter value to enable or disable a sidelink feature or procedure) based on the coordination information indicated in the coordination message, and the UE may perform one or more sidelink transmissions based on the selected values for the one or more sidelink communication parameters.

For example, in some aspects, the coordination information that is communicated from the coordination node to one or more UEs operating in the distributed scheduling mode (e.g., via one or more RSUs or other communication devices) may explicitly indicate a single value for a coordinated sidelink communication parameter (e.g., a sidelink communication parameter that the UE(s) may otherwise autonomously select in the distributed scheduling mode, such as an MCS, a DMRS pattern, a transmit power, a NACK distance threshold for groupcast option 1 operation, whether to enable or disable retransmissions, and/or whether to enable or disable inter-UE coordination, among other examples). In some aspects, in cases where the coordination information explicitly indicates a single value for a coordinated sidelink communication parameter, a UE that receives the coordination message may select the single value explicitly indicated in the coordination information as the value for the corresponding sidelink communication parameter.

For example, the coordination information may include an indication to use a groupcast option 1 NACK distance threshold equal to X meters, in which case each UE applying the coordination information may use groupcast option 1 NACK distance threshold equal to X meters when performing a sidelink transmission based on groupcast option 1. In another example, the coordination information may include an indication to use a transmit power equal to Y decibel-milliwatts (dBm), in which case each UE applying the coordination information may use a transmit power equal to Y dBm when performing a sidelink transmission. Furthermore, as described herein, the single value indicated in the coordination information may be a numerical value, or the single value may be a binary value to indicate whether a sidelink communication feature or procedure is enabled or disabled. For example, the coordination information may include a binary indication to enable or disable retransmissions and/or a binary indication to enable or disable inter-UE coordination, and each UE applying the coordination information may enable or disable retransmissions and/or inter-UE coordination based on the binary indication(s) in the coordination information.

Additionally, or alternatively, in some aspects, the coordination information that is communicated from the coordination node to one or more UEs operating in the distributed scheduling mode may indicate a range of permitted values for a coordinated sidelink communication parameter (e.g., based on minimum and maximum thresholds), and each UE that applies the coordination information carried in the coordination message may independently or autonomously select a value for the coordinated sidelink communication parameter within the range of permitted values indicated in the coordination information. For example, in some aspects, the coordination information may include an indication to use any NACK distance threshold between Xₘᵢₙ and Xₘₐₓ meters, where Xₘᵢₙ<Xₘₐₓ, and each UE applying the coordination information may autonomously select any suitable NACK distance threshold between Xₘᵢₙ and Xₘₐₓ (e.g., based on UE-specific reliability requirements). In another example, the coordination information may include an indication to select any transmit power that does not exceed Yₘₐₓ dBm, and each UE applying the coordination information may autonomously select any suitable transmit power that does not exceed Yₘₐₓ dBm. In this way, using a range of permitted values may enable coordination to occur at a global level to maximize one or more system-wide performance metrics (e.g., reducing collisions or increasing an average PRR) while providing UEs with flexibility to select suitable parameter values to selfishly maximize local UE-specific performance metrics.

Additionally, or alternatively, in some aspects, the coordination information that is communicated from the coordination node to the UEs operating in the distributed scheduling mode may indicate a pattern or sequence of values along with information that indicates when to apply each value in the pattern or sequence of values. For example, the coordination information may include a NACK distance threshold of 50 meters, 100 meters, and 200 meters (or X meters, 2X meters, and 4X meters) for the next three frames (e.g., starting with the frame after the frame in which the coordination message is received), and each UE that performs a sidelink transmission in one or more of the next three frames using groupcast option 1 may use the corresponding NACK distance threshold associated with the appropriate frame(s). In this way, using a pattern or sequence of values may provide a more efficient mechanism to communicate frequent changes to parameter values (e.g., relative to communicating multiple coordination messages to coordinate the parameter values to use at different times). For example, there may be frequent changes to one or more parameter values during a training or learning phase when the coordination node is (re-)selecting the sidelink communication parameters to coordinate and/or (re-)selecting the values to use for the coordinated sidelink communication parameters. In such cases, the coordination information may indicate one or more parameter values according to a pattern or sequence of values to efficiently communicate changes to parameter values while obtaining observations related to performance associated with varying parameter values.

Additionally, or alternatively, in some aspects, the coordination information that is communicated from the coordination node to the UEs operating in the distributed scheduling mode may indicate one or more combinations of values that are allowed or disallowed when a UE is selecting values for multiple sidelink communication parameters that the UE is jointly using to perform a sidelink transmission. For example, the coordination information may include an indication to use a NACK distance threshold greater than Y meters when performing a groupcast option 1 transmission with a transmit power below X dBm (e.g., if the transmit power is less than X dBm, select a groupcast 1 option NACK distance threshold greater than Y meters). Additionally, or alternatively, the coordination information may indicate one or more conditions and/or corresponding parameter values. For example, the coordination information may include an indication to select a NACK distance threshold equal to Y meters when transmitting a packet with a priority greater than X, and to otherwise select a NACK distance threshold equal to Z meters when transmitting a packet with a priority equal to or less than X. In another example, the one or more conditions may relate to one or more measurements or observations associated with the sidelink environment. For example, the coordination information may include an indication to enable an inter-UE coordination feature to reduce collisions if a number of colliding observed reservations exceeds X per unit of time (e.g., per slot or per frame).

Additionally, or alternatively, in some aspects, the coordination information that is communicated from the coordination node to the UEs operating in the distributed scheduling mode may indicate that coordination is released for one or more sidelink communication parameters that were previously coordinated in any suitable manner described herein. For example, the coordination information may indicate that a coordinated sidelink communication parameter is no longer subject to coordination, whereby each UE applying the coordination information is permitted to independently select any suitable value for the released sidelink communication parameter. Furthermore, in some aspects, the UE(s) applying the coordination information may be permitted to independently select any value for the released sidelink communication parameter any time after the coordination message is received or after a specific time that may be indicated in the coordination message (e.g., after the current frame or slot).

In some aspects, as described herein, the coordination information that is communicated from the coordination node to the UEs operating in the distributed scheduling mode may be associated with one or more restrictions, whereby a UE that receives the coordination message may apply the coordination information carried in the coordination message in cases where the UE satisfies the one or more restrictions. In some aspects, the one or more restrictions may be applicable to all parameter values that are indicated in the coordination message and/or to a subset of the parameter values that are indicated in the coordination message. For example, in some aspects, one or more parameter values indicated in the coordination message may be restricted to be applied only by UEs that satisfy one or more criteria (e.g., UEs that have a subscription to a parameter coordination service associated with the distributed scheduling mode and/or UEs that have requested to be included in the coordination), only by UEs that are within a certain geographical area or zone, and/or only by one or more sidelink applications (e.g., BSM transmissions) regardless of the UE originating the corresponding sidelink transmission, among other examples. In some aspects, the one or more restrictions associated with the coordination message may be indicated in the coordination message, in which case the coordination information may indicate multiple values that different UEs are to apply for the same sidelink communication parameter. For example, the coordination information may include an indication that UEs located in a first zone are to select a groupcast option 1 NACK distance threshold equal to X meters, and that UEs located in a second zone are to select a groupcast option 1 NACK distance threshold equal to Y meters, among other examples. Additionally, or alternatively, in some cases, the restriction(s) may be implicitly enforced by the coordination node. For example, in some aspects, the coordination node may enforce the restrictions by communicating a unicast message and/or a groupcast option 2 message only to the UEs that are to apply the coordination information. In this case, the coordination message may not impose any restrictions, as any UEs that receive the coordination message are expected to apply the parameter value(s) indicated in the coordination message and any UEs that do not receive the coordination message may be permitted to autonomously select the values for the coordinated sidelink communication parameter(s).

In some aspects, as described herein, the coordination information that is communicated from the coordination node to the UEs operating in the distributed scheduling mode may be associated with a validity period, whereby a UE that receives the coordination message may apply the coordination information carried in the coordination message in cases where the validity period has not elapsed. For example, in some aspects, when a UE receives a coordination message that indicates a value and/or selection criteria for a coordinated sidelink communication parameter, the indication may be valid from the time that the coordination message is received until a timer expires. In other examples, the indication may be valid over a future interval (e.g., apply the indicated value and/or selection criteria over a duration of a frame with a particular system frame number (SFN) or another suitable time window), from a start time (e.g., the time when the coordination message is received or a future point in time, such as the start of the next slot after the coordination message is received) until a new coordination message is received with a new or updated value and/or selection criteria for the coordinated sidelink communication parameter, and/or over a specified time schedule or pattern (e.g., indicating that a parameter value is to be applied over the next N even-indexed frames). In some aspects, the manner in which the validity period is defined may be preconfigured or indicated in the coordination message.

In some cases, a UE that has been applying coordination information for one or more sidelink communication parameters may determine that the coordination information is no longer applicable. For example, in some aspects, the UE may determine that the coordination information is no longer applicable based on the validity period having elapsed (e.g., the timer associated with the coordinated parameter value has expired) and/or based on the UE no longer satisfying one or more restrictions associated with the coordination information (e.g., the coordinated parameter value only applied to a geographical zone that the UE just left). In such cases (e.g., when a restriction associated with the coordination information is not satisfied and/or a validity period associated with the coordination information has elapsed), the UE may select the value for the sidelink communication parameter autonomously, select a fallback value for the sidelink communication parameter (e.g., a preconfigured default value or a value indicated in the most recent coordination message received by the UE), and/or observe sidelink transmissions by other UEs to identify and adopt the value that the other UEs are using for the sidelink communication parameter. For example, a UE that applies a coordinated value for a groupcast option 1 NACK distance threshold may observe one or more groupcast option 1 messages, identify the NACK distance threshold associated with the observed groupcast option 1 messages, and select the NACK distance threshold associated with the observed groupcast option 1 messages for outgoing groupcast option 1 transmissions.

Accordingly, to enable receiving UEs to determine the coordinated parameter values, sidelink transmissions by UEs that are applying the coordination information may include an explicit indication as to whether the transmitting UEs are using the most recent coordinated parameter value indicated by the coordination node (e.g., using a one-bit field in SCI or a medium access control (MAC) control element (MAC-CE)). For example, a UE may generally know that the UE has received the most recent parameter update (e.g., because the coordination message transmissions may be periodic), whereby the UE may know whether the most recent coordination message received by the UE was the most recent coordination message communicated by the coordination node or whether there were one or more subsequent coordination message transmissions that the UE missed (e.g., due to a decoding failure). Accordingly, a UE that observes a sidelink transmission associated with an indication that the parameter values used therein are the most recent values coordinated by the coordination node may safely apply the parameter value used in the sidelink transmission (e.g., because the parameter value was coordinated by the coordination node and not autonomously or arbitrarily selected by the transmitting UE).

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with parameter-level coordination for sidelink communication in a distributed scheduling mode.

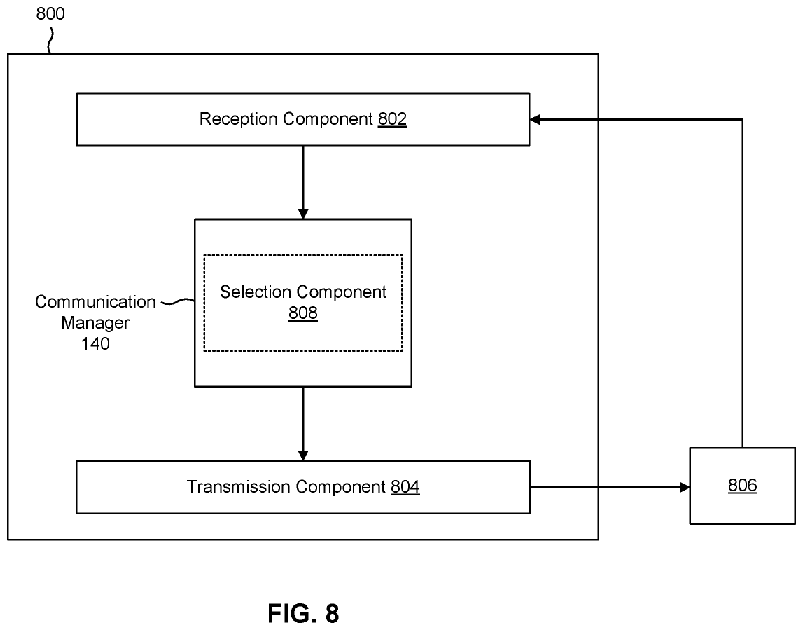

As shown in FIG. 6, in some aspects, process 600 may include receiving coordination information for sidelink communication in a distributed scheduling mode (block 610). For example, the UE (e.g., using communication manager 140 and/or reception component 802, depicted in FIG. 8) may receive coordination information for sidelink communication in a distributed scheduling mode, as described above.

As further shown in FIG. 6, in some aspects, process 600 may include selecting, in the distributed scheduling mode, a value for a sidelink communication parameter based at least in part on the coordination information (block 620). For example, the UE (e.g., using communication manager 140 and/or selection component 808, depicted in FIG. 8) may select, in the distributed scheduling mode, a value for a sidelink communication parameter based at least in part on the coordination information, as described above.

As further shown in FIG. 6, in some aspects, process 600 may include transmitting a sidelink communication using the value of the sidelink communication parameter that is selected based at least in part on the coordination information (block 630). For example, the UE (e.g., using communication manager 140 and/or transmission component 804, depicted in FIG. 8) may transmit a sidelink communication using the value of the sidelink communication parameter that is selected based at least in part on the coordination information, as described above.

Process 600 may include additional aspects, such as any single aspect or any combination of aspects described below and/or in connection with one or more other processes described elsewhere herein.

In a first aspect, the coordination information indicates the value for the sidelink communication parameter.

In a second aspect, alone or in combination with the first aspect, the coordination information indicates a range of permitted values for the sidelink communication parameter, and the value for the sidelink communication parameter is selected within the range of permitted values.

In a third aspect, alone or in combination with one or more of the first and second aspects, the coordination information indicates a pattern or sequence of values for the sidelink communication parameter and indicates information related to when to apply each value in the pattern or sequence of values.

In a fourth aspect, alone or in combination with one or more of the first through third aspects, the coordination information indicates whether one or more sidelink features or sidelink procedures are enabled or disabled.

In a fifth aspect, alone or in combination with one or more of the first through fourth aspects, the coordination information indicates that the sidelink communication parameter is not subject to coordination in the distributed scheduling mode, and the value for the sidelink communication parameter is autonomously selected based at least in part on the coordination information indicating that the sidelink communication parameter is not subject to coordination in the distributed scheduling mode.

In a sixth aspect, alone or in combination with one or more of the first through fifth aspects, the coordination information indicates one or more of an allowed combination of values or a disallowed combination of values for multiple sidelink communication parameters that are jointly used for the sidelink communication.

In a seventh aspect, alone or in combination with one or more of the first through sixth aspects, the coordination information indicates one or more conditions for selecting the value for the sidelink communication parameter.

In an eighth aspect, alone or in combination with one or more of the first through seventh aspects, the coordination information is associated with one or more restrictions, and the value for the sidelink communication parameter is selected based at least in part on a determination that the one or more restrictions associated with the coordination information are satisfied.

In a ninth aspect, alone or in combination with one or more of the first through eighth aspects, the one or more restrictions include the UE having a subscription to a sidelink parameter coordination service, the UE requesting inclusion in the sidelink parameter coordination service, the UE having a location within a geographical area, or the sidelink communication being associated with one or more sidelink applications.

In a tenth aspect, alone or in combination with one or more of the first through ninth aspects, the value for the sidelink communication parameter is selected according to the coordination information based at least in part on determining that a validity period associated with the coordination information has not elapsed.

In an eleventh aspect, alone or in combination with one or more of the first through tenth aspects, the validity period ends when a timer expires, after an interval has elapsed, when the coordination information is updated, or after the coordination information has been applied according to a specified schedule.

In a twelfth aspect, alone or in combination with one or more of the first through eleventh aspects, the validity period starts when the coordination information is received or a specified time after the coordination information is received.

In a thirteenth aspect, alone or in combination with one or more of the first through twelfth aspects, process 600 includes selecting, in the distributed scheduling mode, an updated value for the sidelink communication parameter autonomously based at least in part on determining that a restriction associated with the coordination information is not satisfied or that a validity period associated with the coordination information has elapsed.

In a fourteenth aspect, alone or in combination with one or more of the first through thirteenth aspects, process 600 includes selecting, in the distributed scheduling mode, an updated value for the sidelink communication parameter according to a fallback value based at least in part on determining that a restriction associated with the coordination information is not satisfied or that a validity period associated with the coordination information has elapsed.

In a fifteenth aspect, alone or in combination with one or more of the first through fourteenth aspects, process 600 includes selecting, in the distributed scheduling mode, an updated value for the sidelink communication parameter according to values that other UEs are using for the sidelink communication parameter, based at least in part on determining that a restriction associated with the coordination information is not satisfied or that a validity period associated with the coordination information has elapsed.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a coordination node, in accordance with the present disclosure. Example process 700 is an example where the coordination node performs operations associated with parameter-level coordination for sidelink communication in a distributed scheduling mode.

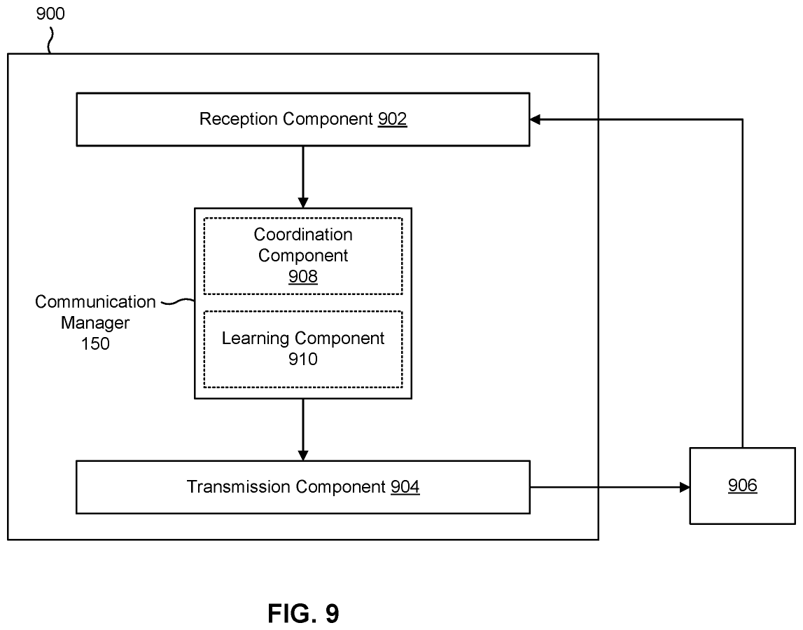

As shown in FIG. 7, in some aspects, process 700 may include generating coordination information for sidelink communication in a distributed scheduling mode (block 710). For example, the coordination node (e.g., using communication manager 150 and/or coordination component 908, depicted in FIG. 9) may generate coordination information for sidelink communication in a distributed scheduling mode, as described above.

As further shown in FIG. 7, in some aspects, process 700 may include transmitting the coordination information to one or more UEs, wherein the coordination information indicates a value that the one or more UEs are to use for a sidelink communication parameter or indicates whether one or more sidelink features or procedures are enabled or disabled (block 720). For example, the coordination node (e.g., using communication manager 150 and/or transmission component 904, depicted in FIG. 9) may transmit the coordination information to one or more UEs, wherein the coordination information indicates a value that the one or more UEs are to use for a sidelink communication parameter or indicates whether one or more sidelink features or procedures are enabled or disabled, as described above.

Process 700 may include additional aspects, such as any single aspect or any combination of aspects described below and/or in connection with one or more other processes described elsewhere herein.

In a first aspect, process 700 includes obtaining one or more observations that relate to performance for different values for the sidelink communication parameter and different combinations of values for different sidelink communication parameters with respect to one or more key performance indicators, and applying one or more machine learning techniques to determine the coordination information based at least in part on the one or more observations.

In a second aspect, alone or in combination with the first aspect, the coordination information indicates the value for the sidelink communication parameter according to a single value.

In a third aspect, alone or in combination with one or more of the first and second aspects, the coordination information indicates a range of permitted values for the sidelink communication parameter.

In a fourth aspect, alone or in combination with one or more of the first through third aspects, the coordination information indicates a pattern or sequence of values for the sidelink communication parameter and indicates information related to when to apply each value in the pattern or sequence of values.

In a fifth aspect, alone or in combination with one or more of the first through fourth aspects, the coordination information indicates whether one or more sidelink features or sidelink procedures are enabled or disabled.

In a sixth aspect, alone or in combination with one or more of the first through fifth aspects, the coordination information indicates that the sidelink communication parameter is not subject to coordination in the distributed scheduling mode such that the one or more UEs are permitted to autonomously select the value for the sidelink communication parameter.

In a seventh aspect, alone or in combination with one or more of the first through sixth aspects, the coordination information indicates one or more of an allowed combination of values or a disallowed combination of values for multiple sidelink communication parameters that are jointly used for a sidelink communication.

In an eighth aspect, alone or in combination with one or more of the first through seventh aspects, the coordination information indicates one or more conditions that the one or more UEs are to use to select the value for the sidelink communication parameter.

In a ninth aspect, alone or in combination with one or more of the first through eighth aspects, the coordination information is associated with one or more restrictions.

In a tenth aspect, alone or in combination with one or more of the first through ninth aspects, the one or more restrictions include the one or more UEs having a subscription to a sidelink parameter coordination service, the one or more UEs requesting inclusion in the sidelink parameter coordination service, the one or more UEs having respective locations within a geographical area, or the one or more UEs transmitting a sidelink communication associated with one or more sidelink applications.

In an eleventh aspect, alone or in combination with one or more of the first through tenth aspects, the coordination information is transmitted to the one or more UEs based at least in part on determining that the one or more UEs satisfy the one or more restrictions associated with the coordination information.

In a twelfth aspect, alone or in combination with one or more of the first through eleventh aspects, the coordination information is associated with a validity period.

In a thirteenth aspect, alone or in combination with one or more of the first through twelfth aspects, the validity period ends when a timer expires, after an interval has elapsed, when the coordination information is updated, or after the coordination information has been applied according to a specified schedule.

In a fourteenth aspect, alone or in combination with one or more of the first through thirteenth aspects, the validity period starts when the coordination information is received by the one or more UEs or a specified time after the coordination information is received by the one or more UEs.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include a selection component 808, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive coordination information for sidelink communication in a distributed scheduling mode. The selection component 808 may select, in the distributed scheduling mode, a value for a sidelink communication parameter based at least in part on the coordination information. The transmission component 804 may transmit a sidelink communication using the value of the sidelink communication parameter that is selected based at least in part on the coordination information.

The selection component 808 may select, in the distributed scheduling mode, an updated value for the sidelink communication parameter autonomously based at least in part on determining that a restriction associated with the coordination information is not satisfied or that a validity period associated with the coordination information has elapsed.

The selection component 808 may select, in the distributed scheduling mode, an updated value for the sidelink communication parameter according to a fallback value based at least in part on determining that a restriction associated with the coordination information is not satisfied or that a validity period associated with the coordination information has elapsed.

The selection component 808 may select, in the distributed scheduling mode, an updated value for the sidelink communication parameter according to values that other UEs are using for the sidelink communication parameter, based at least in part on determining that a restriction associated with the coordination information is not satisfied or that a validity period associated with the coordination information has elapsed.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a coordination node, or a coordination node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include one or more of a coordination component 908 or a learning component 910, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the coordination node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the coordination node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the coordination node described in connection with FIG. 2. In some aspects, the transmission component 904 may be co-located with the reception component 902 in a transceiver.

The coordination component 908 may generate coordination information for sidelink communication in a distributed scheduling mode. The transmission component 904 may transmit the coordination information to one or more UEs, wherein the coordination information indicates a value that the one or more UEs are to use for a sidelink communication parameter or indicates whether one or more sidelink features or procedures are enabled or disabled.

The learning component 910 may obtain one or more observations that relate to performance for different values for the sidelink communication parameter and different combinations of values for different sidelink communication parameters with respect to one or more key performance indicators. The learning component 910 may apply one or more machine learning techniques to determine the coordination information based at least in part on the one or more observations.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving coordination information for sidelink communication in a distributed scheduling mode; selecting, in the distributed scheduling mode, a value for a sidelink communication parameter based at least in part on the coordination information; and transmitting a sidelink communication using the value of the sidelink communication parameter that is selected based at least in part on the coordination information.

Aspect 2: The method of Aspect 1, wherein the coordination information indicates the value for the sidelink communication parameter.

Aspect 3: The method of any of Aspects 1-2, wherein the coordination information indicates a range of permitted values for the sidelink communication parameter, and wherein the value for the sidelink communication parameter is selected within the range of permitted values.

Aspect 4: The method of any of Aspects 1-3, wherein the coordination information indicates a pattern or sequence of values for the sidelink communication parameter and indicates information related to when to apply each value in the pattern or sequence of values.

Aspect 5: The method of any of Aspects 1-4, wherein the coordination information indicates whether one or more sidelink features or sidelink procedures are enabled or disabled.

Aspect 6: The method of any of Aspects 1-5, wherein the coordination information indicates that the sidelink communication parameter is not subject to coordination in the distributed scheduling mode, and wherein the value for the sidelink communication parameter is autonomously selected based at least in part on the coordination information indicating that the sidelink communication parameter is not subject to coordination in the distributed scheduling mode.

Aspect 7: The method of any of Aspects 1-6, wherein the coordination information indicates one or more of an allowed combination of values or a disallowed combination of values for multiple sidelink communication parameters that are jointly used for the sidelink communication.

Aspect 8: The method of any of Aspects 1-7, wherein the coordination information indicates one or more conditions for selecting the value for the sidelink communication parameter.

Aspect 9: The method of any of Aspects 1-8, wherein the coordination information is associated with one or more restrictions, and wherein the value for the sidelink communication parameter is selected based at least in part on a determination that the one or more restrictions associated with the coordination information are satisfied.

Aspect 10: The method of Aspect 9, wherein the one or more restrictions include the UE having a subscription to a sidelink parameter coordination service, the UE requesting inclusion in the sidelink parameter coordination service, the UE having a location within a geographical area, or the sidelink communication being associated with one or more sidelink applications.

Aspect 11: The method of any of Aspects 1-10, wherein the value for the sidelink communication parameter is selected according to the coordination information based at least in part on determining that a validity period associated with the coordination information has not elapsed.

Aspect 12: The method of Aspect 11, wherein the validity period ends when a timer expires, after an interval has elapsed, when the coordination information is updated, or after the coordination information has been applied according to a specified schedule.

Aspect 13: The method of any of Aspects 11-12, wherein the validity period starts when the coordination information is received or a specified time after the coordination information is received.

Aspect 14: The method of any of Aspects 1-13, further comprising; selecting, in the distributed scheduling mode, an updated value for the sidelink communication parameter autonomously based at least in part on determining that a restriction associated with the coordination information is not satisfied or that a validity period associated with the coordination information has elapsed.

Aspect 15: The method of any of Aspects 1-13, further comprising; selecting, in the distributed scheduling mode, an updated value for the sidelink communication parameter according to a fallback value based at least in part on determining that a restriction associated with the coordination information is not satisfied or that a validity period associated with the coordination information has elapsed.

Aspect 16: The method of any of Aspects 1-13, further comprising; selecting, in the distributed scheduling mode, an updated value for the sidelink communication parameter according to values that other UEs are using for the sidelink communication parameter, based at least in part on determining that a restriction associated with the coordination information is not satisfied or that a validity period associated with the coordination information has elapsed.

Aspect 17: A method of wireless communication performed by a coordination node, comprising; generating coordination information for sidelink communication in a distributed scheduling mode; and transmitting the coordination information to one or more UEs, wherein the coordination information indicates a value that the one or more UEs are to use for a sidelink communication parameter or indicates whether one or more sidelink features or procedures are enabled or disabled.

Aspect 18: The method of Aspect 17, further comprising; obtaining one or more observations that relate to performance for different values for the sidelink communication parameter and different combinations of values for different sidelink communication parameters with respect to one or more key performance indicators; and applying one or more machine learning techniques to determine the coordination information based at least in part on the one or more observations.

Aspect 19: The method of any of Aspects 17-18, wherein the coordination information indicates the value for the sidelink communication parameter according to a single value.

Aspect 20: The method of any of Aspects 17-19, wherein the coordination information indicates a range of permitted values for the sidelink communication parameter.

Aspect 21: The method of any of Aspects 17-20, wherein the coordination information indicates a pattern or sequence of values for the sidelink communication parameter and indicates information related to when to apply each value in the pattern or sequence of values.

Aspect 22: The method of any of Aspects 17-21, wherein the coordination information indicates whether one or more sidelink features or sidelink procedures are enabled or disabled.

Aspect 23: The method of any of Aspects 17-22, wherein the coordination information indicates that the sidelink communication parameter is not subject to coordination in the distributed scheduling mode such that the one or more UEs are permitted to autonomously select the value for the sidelink communication parameter.

Aspect 24: The method of any of Aspects 17-23, wherein the coordination information indicates one or more of an allowed combination of values or a disallowed combination of values for multiple sidelink communication parameters that are jointly used for a sidelink communication.

Aspect 25: The method of any of Aspects 17-24, wherein the coordination information indicates one or more conditions that the one or more UEs are to use to select the value for the sidelink communication parameter.

Aspect 26: The method of any of Aspects 17-25, wherein the coordination information is associated with one or more restrictions.

Aspect 27: The method of Aspect 26, wherein the one or more restrictions include the one or more UEs having a subscription to a sidelink parameter coordination service, the one or more UEs requesting inclusion in the sidelink parameter coordination service, the one or more UEs having respective locations within a geographical area, or the one or more UEs transmitting a sidelink communication associated with one or more sidelink applications.

Aspect 28: The method of any of Aspects 26-27, wherein the coordination information is transmitted to the one or more UEs based at least in part on determining that the one or more UEs satisfy the one or more restrictions associated with the coordination information.

Aspect 29: The method of any of Aspects 17-28, wherein the coordination information is associated with a validity period.

Aspect 30: The method of Aspect 29, wherein the validity period ends when a timer expires, after an interval has elapsed, when the coordination information is updated, or after the coordination information has been applied according to a specified schedule.

Aspect 31: The method of any of Aspects 29-30, wherein the validity period starts when the coordination information is received by the one or more UEs or a specified time after the coordination information is received by the one or more UEs.

Aspect 32: An apparatus for wireless communication at a device, comprising a processor; memory coupled with the processor; and instructions stored in the memory and executable by the processor to cause the apparatus to perform the method of one or more of Aspects 1-16.

Aspect 33: A device for wireless communication, comprising a memory and one or more processors coupled to the memory, the one or more processors configured to perform the method of one or more of Aspects 1-16.

Aspect 34: An apparatus for wireless communication, comprising at least one means for performing the method of one or more of Aspects 1-16.

Aspect 35: A non-transitory computer-readable medium storing code for wireless communication, the code comprising instructions executable by a processor to perform the method of one or more of Aspects 1-16.

Aspect 36: A non-transitory computer-readable medium storing a set of instructions for wireless communication, the set of instructions comprising one or more instructions that, when executed by one or more processors of a device, cause the device to perform the method of one or more of Aspects 1-16.

Aspect 37: An apparatus for wireless communication at a device, comprising a processor; memory coupled with the processor; and instructions stored in the memory and executable by the processor to cause the apparatus to perform the method of one or more of Aspects 17-31.

Aspect 38: A device for wireless communication, comprising a memory and one or more processors coupled to the memory, the one or more processors configured to perform the method of one or more of Aspects 17-31.

Aspect 39: An apparatus for wireless communication, comprising at least one means for performing the method of one or more of Aspects 17-31.

Aspect 40: A non-transitory computer-readable medium storing code for wireless communication, the code comprising instructions executable by a processor to perform the method of one or more of Aspects 17-31.

Aspect 41: A non-transitory computer-readable medium storing a set of instructions for wireless communication, the set of instructions comprising one or more instructions that, when executed by one or more processors of a device, cause the device to perform the method of one or more of Aspects 17-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive coordination information for sidelink communication in a distributed scheduling mode;
select, in the distributed scheduling mode, a value for a sidelink communication parameter based at least in part on the coordination information; and
transmit a sidelink communication using the value of the sidelink communication parameter that is selected based at least in part on the coordination information.

2. The UE of claim 1, wherein the coordination information indicates the value for the sidelink communication parameter.

3. The UE of claim 1, wherein the coordination information indicates a range of permitted values for the sidelink communication parameter, and wherein the value for the sidelink communication parameter is selected within the range of permitted values.

4. The UE of claim 1, wherein the coordination information indicates a pattern or sequence of values for the sidelink communication parameter and indicates information related to when to apply each value in the pattern or sequence of values.

5. The UE of claim 1, wherein the coordination information indicates whether one or more sidelink features or sidelink procedures are enabled or disabled.

6. The UE of claim 1, wherein the coordination information indicates that the sidelink communication parameter is not subject to coordination in the distributed scheduling mode, and wherein the value for the sidelink communication parameter is autonomously selected based at least in part on the coordination information indicating that the sidelink communication parameter is not subject to coordination in the distributed scheduling mode.

7. The UE of claim 1, wherein the coordination information indicates one or more of an allowed combination of values or a disallowed combination of values for multiple sidelink communication parameters that are jointly used for the sidelink communication.

8. The UE of claim 1, wherein the coordination information indicates one or more conditions for selecting the value for the sidelink communication parameter.

9. The UE of claim 1, wherein the coordination information is associated with one or more restrictions, and wherein the value for the sidelink communication parameter is selected based at least in part on a determination that the one or more restrictions associated with the coordination information are satisfied.

10. The UE of claim 9, wherein the one or more restrictions include the UE having a subscription to a sidelink parameter coordination service, the UE requesting inclusion in the sidelink parameter coordination service, the UE having a location within a geographical area, or the sidelink communication being associated with one or more sidelink applications.

11. The UE of claim 1, wherein the value for the sidelink communication parameter is selected according to the coordination information based at least in part on determining that a validity period associated with the coordination information has not elapsed.

12. The UE of claim 11, wherein the validity period ends when a timer expires, after an interval has elapsed, when the coordination information is updated, or after the coordination information has been applied according to a specified schedule.

13. The UE of claim 11, wherein the validity period starts when the coordination information is received or a specified time after the coordination information is received.

14. The UE of claim 1, wherein the one or more processors are further configured to:
select, in the distributed scheduling mode, an updated value for the sidelink communication parameter autonomously based at least in part on determining that a restriction associated with the coordination information is not satisfied or that a validity period associated with the coordination information has elapsed.

15. The UE of claim 1, wherein the one or more processors are further configured to:
select, in the distributed scheduling mode, an updated value for the sidelink communication parameter according to a fallback value based at least in part on determining that a restriction associated with the coordination information is not satisfied or that a validity period associated with the coordination information has elapsed.

16. The UE of claim 1, wherein the one or more processors are further configured to:
select, in the distributed scheduling mode, an updated value for the sidelink communication parameter according to values that other UEs are using for the sidelink communication parameter, based at least in part on determining that a restriction associated with the coordination information is not satisfied or that a validity period associated with the coordination information has elapsed.

17. A coordination node for wireless communication, comprising:
a memory; and
one or more processors, coupled to the memory, configured to:
generate coordination information for sidelink communication in a distributed scheduling mode; and
transmit the coordination information to one or more user equipments (UEs), wherein the coordination information indicates a value that the one or more UEs are to use for a sidelink communication parameter or indicates whether one or more sidelink features or procedures are enabled or disabled.

18. The coordination node of claim 17, wherein the one or more processors are further configured to:
obtain one or more observations that relate to performance for different values for the sidelink communication parameter and different combinations of values for different sidelink communication parameters with respect to one or more key performance indicators; and
apply one or more machine learning techniques to determine the coordination information based at least in part on the one or more observations.

19. The coordination node of claim 17, wherein the coordination information indicates the value for the sidelink communication parameter according to a single value, indicates a range of permitted values for the sidelink communication parameter, or indicates a pattern or sequence of values for the sidelink communication parameter and information related to when to apply each value in the pattern or sequence of values.

20. The coordination node of claim 17, wherein the coordination information indicates whether one or more sidelink features or sidelink procedures are enabled or disabled.

21. The coordination node of claim 17, wherein the coordination information indicates that the sidelink communication parameter is not subject to coordination in the distributed scheduling mode such that the one or more UEs are permitted to autonomously select the value for the sidelink communication parameter.

22. The coordination node of claim 17, wherein the coordination information indicates one or more of an allowed combination of values or a disallowed combination of values for multiple sidelink communication parameters that are jointly used for a sidelink communication.

23. The coordination node of claim 17, wherein the coordination information indicates one or more conditions that the one or more UEs are to use to select the value for the sidelink communication parameter.

24. The coordination node of claim 17, wherein the coordination information is associated with one or more restrictions.

25. The coordination node of claim 24, wherein the one or more restrictions include the one or more UEs having a subscription to a sidelink parameter coordination service, the one or more UEs requesting inclusion in the sidelink parameter coordination service, the one or more UEs having respective locations within a geographical area, or the one or more UEs transmitting a sidelink communication associated with one or more sidelink applications.

26. The coordination node of claim 24, wherein the coordination information is transmitted to the one or more UEs based at least in part on determining that the one or more UEs satisfy the one or more restrictions associated with the coordination information.

27. The coordination node of claim 17, wherein the coordination information is associated with a validity period.

28. The coordination node of claim 27, wherein;
the validity period starts when the coordination information is received by the one or more UEs or a specified time after the coordination information is received by the one or more UEs, and
the validity period ends when a timer expires, after an interval has elapsed, when the coordination information is updated, or after the coordination information has been applied according to a specified schedule.

29. A method of wireless communication performed by a user equipment (UE), comprising:
receiving coordination information for sidelink communication in a distributed scheduling mode;
selecting, in the distributed scheduling mode, a value for a sidelink communication parameter based at least in part on the coordination information; and
transmitting a sidelink communication using the value of the sidelink communication parameter that is selected based at least in part on the coordination information.

30. A method of wireless communication performed by a coordination node, comprising:
generating coordination information for sidelink communication in a distributed scheduling mode; and
transmitting the coordination information to one or more user equipments (UEs), wherein the coordination information indicates a value that the one or more UEs are to use for a sidelink communication parameter or indicates whether one or more sidelink features or procedures are enabled or disabled.

31. (canceled)
